(19) United States
(12) Patent Application Publication
(10) Pub. No.: US 2025/0024530 A1
(43) Pub. Date: Jan. 16, 2025

(54) METHOD AND APPARATUS TO CONFIGURE AND SUPPORT VARIOUS PDCP VERSION IN SPLIT RAN ARCHITECTURE IN A COMMUNICATION SYSTEM

(71) Applicant: SAMSUNG ELECTRONICS CO., LTD., Suwon-si (KR)

(72) Inventors: Beomsik BAE, Suwon-si (KR); Jinwoo OCK, Suwon-si (KR); Sangkyu BAEK, Suwon-si (KR)

(21) Appl. No.: 18/769,130

(22) Filed: Jul. 10, 2024

(30) Foreign Application Priority Data
Jul. 10, 2023 (KR) 10-2023-0088854

(51) Int. Cl. H04W 76/12

(52) U.S. Cl. CPC H04W 76/12

(57) ABSTRACT

The disclosure relates to a 5G or 6G communication system for supporting a higher data transmission rate. More particularly, the disclosure relates to a method performed by a control plane (CP) of a base station in a wireless communication system. The method comprises transmitting, to a user plane (UP) of the base station, a first message comprising information on a packet data convergence protocol (PDCP) for each data radio bearer (DRB). As a response to the first message, the method further comprises receiving, from the UP of the base station, a second message. The information on the PDCP for each DRB comprises at least one PDCP version.

### CROSS REFERENCE TO RELATED APPLICATION

The present application claims priority under 35 U.S.C. § 119 to Korean Patent Application No. 10-2023-0088854, filed on Jul. 10, 2023, the entire contents of which is incorporated herein for all purposes by this reference.

### BACKGROUND

### 1. Field

The disclosure relates to a communication system, and an operation of a base station, and more specifically, to a method and apparatus for configuring and supporting various PDCP versions in relation to a base station.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

An embodiment provides a method and procedure for configuring and supporting various versions of packet processing protocols, such as packet data convergence protocol (PDCP) versions, for transmission of user data of a terminal in a structure in which a base station function is split in a mobile communication system.

An embodiment provides a method and procedure for solving the problem that only one version of PDCP can be supported in CU-UP (or eNB-UP) in a split RAN structure.

The technical objects to be achieved by the disclosure are not limited to the technical objects mentioned above, and other technical objects not mentioned may be clearly understood by those skilled in the art from the following descriptions.

Based on the discussion as described above, the disclosure may provide a method by a central unit-control plane (CU-CP) in a communication system with a split RAN structure, including transmitting a first control signal to a central unit-user plane (CU-UP); and receiving a second response signal generated by the CU-UP.

In order to solve the above problems, the disclosure provides a control signal processing method in a wireless communication system, including receiving a first control signal transmitted from a base station; processing the received first control signal; and transmitting a second control signal generated based on the processing to the base station.

An embodiment of the disclosure provides an apparatus and method that can effectively provide services in a wireless communication system.

An embodiment provides a method and apparatus for a CU-UP (or eNB-UP) to effectively support PDCP configuration and processing for DRB support in a communication system environment with a split RAN structure.

The effects that can be obtained from the disclosure are not limited to the above mentioned effects, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B each illustrate a diagram of an example of an architecture of a mobile communication system using a split mobile communication base station (split RAN) according to an embodiment of the disclosure.

FIG. 2 illustrates a diagram of a signaling procedure performed with a CU-UP or eNB-UP to configure DRB for a terminal in a CU-CP or eNB-CP according to an embodiment of the disclosure.

FIG. 3 illustrates a diagram of an embodiment related to configuring various PDCP versions through a signaling procedure between a CU-CP or eNB-CP and a CU-UP or eNB-UP and a terminal and core network according to an embodiment of the disclosure.

FIG. 4 illustrates a diagram of an example of a series of procedures including a procedure from a terminal to a core network in which a data radio bearer (DRB) is configured or modified from a CU-CP to a CU-UP or from an eNB-CP to an eNB-UP so as to provide mobile communication services to the terminal while also providing a PDCP version for the corresponding DRB, and thus, in the CU-UP or eNB-UP, a version of a protocol for processing user data packets of the terminal is configured and used in the corresponding DRB according to an embodiment of the disclosure.

FIGS. 5A to 5E each illustrate a diagram of an example of constituting one message including, for each DRB, PDCP version information in the bearer configuration request message (e.g., BEARER CONTEXT SETUP REQUEST message) and bearer modification request message (e.g., BEARER CONTEXT MODIFICATION REQUEST message) transmitted from a CU-CP or eNB-CP to a CU-UP or eNB-UP, which are used in operation 110 in FIG. 2, operation 210 in FIG. 3, and operation 210 in FIG. 4, according to an embodiment of the disclosure.

FIG. 6 illustrates a diagram of an example of a procedure in which a CU-UP or eNB-UP delivers, to a CU-CP or eNB-CP, a protocol version for processing a user data packet of a terminal supported by the CU-UP or eNB-UP, for example, PDCP version information, and thus, the PDCP version may be used in the CU-CP or eNB-CP to configure a DRB for processing the user data packets of the terminal or to select the CU-CP or eNB-CP, according to an embodiment of the disclosure.

FIGS. 7A and 7B each illustrate a diagram of a configuration example of one message including supported PDCP version information in an E1 connection establishment request message (e.g., GNB-CU-UP E1 SETUP REQUEST message) transmitted from a CU-UP or eNB-UP to a CU-CP or eNB-CP and a CU-UP/eNB-UP configuration information update message (e.g., GNB-CU-UP CONFIGURATION UPDATE message), used in operation 100 in FIG. 6, according to an embodiment of the disclosure.

FIGS. 8A and 8B each illustrate a diagram of an example of a series of procedures including a procedure from a terminal to a core network in which a CU-UP or eNB-UP delivers, to a CU-CP or eNB-CP, a protocol version for processing the user data packet of the terminal supported by the CU-UP or eNB-UP, for example, PDCP version information, and the protocol version is used to configure the DRB for processing the user data packet of the terminal in the CU-CP or eNB-CP or select the CU-UP or eNB-UP, and a data radio bearer (DRB) is configured from the CU-CP to the CU-UP or from the eNB-CP to the eNB-UP so as to provide mobile communication services to the terminal while providing the PDCP version to the corresponding DRB, so that in the CU-UP or eNB-UP, the version of the protocol for processing the user data packet of the terminal may be configured and used in the corresponding DRB, according to an embodiment of the disclosure.

FIG. 9 illustrates a flowchart of a procedure for configuring or changing DRB within CU-CP or eNB-CP according to an embodiment of the disclosure.

FIG. 10 illustrates a block diagram of an example of a structure of a base station (RAN Node or eNB or gNB) according to an embodiment of the disclosure.

FIG. 11 illustrates a diagram of a structure of a terminal (User equipment, UE) according to an embodiment of the disclosure.

### DETAILED DESCRIPTION

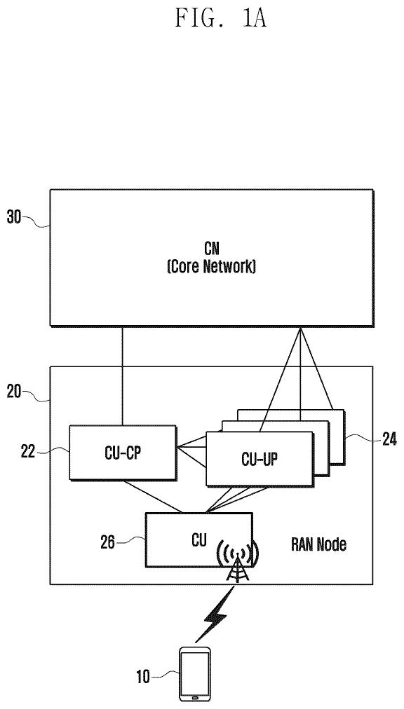

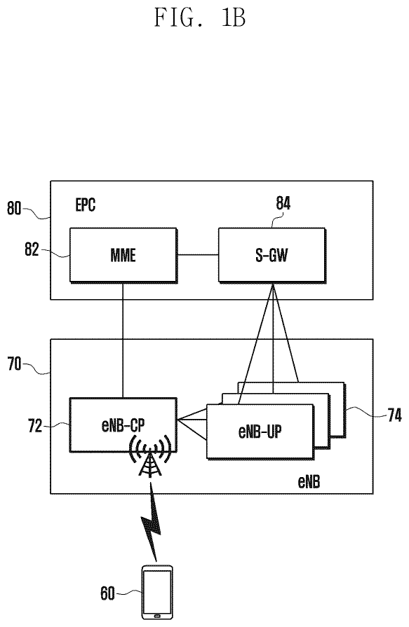

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, preferred embodiments of the disclosure will be described in detail with reference to the accompanying drawings. In this case, it is to be noted that if possible, the same constituent elements are denoted by the same reference numerals in the accompanying drawings.

In the following description of the disclosure, if a detailed description of a related known function or configuration is determined to unnecessarily obscure the gist of the disclosure, the detailed description thereof will be omitted. In describing the embodiments in the specification, explanation of technical contents that are well known in the technical field to which the disclosure pertains and are not directly related to the disclosure may be omitted. This is to transfer the subject matter of the disclosure more clearly without obscuring the same through omission of unnecessary explanations.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. Because these computer program instructions may be embedded in a processor of a general-purpose computer, a special-purpose computer, or other programmable data processing apparatuses, the instructions executed through the processor of the computer or other programmable data processing apparatus generates means for performing the functions described in the flowchart block(s). Because these computer program instructions may also be stored in a computer usable or computer-readable memory that may direct the computer or other programmable data processing apparatus so as to implement functions in a particular manner, the instructions stored in the computer usable or computer-readable memory are also capable of producing an article of manufacture containing instruction modules for performing the functions described in the flowchart block(s). Because the computer program instructions may also be embedded into the computer or other programmable data processing apparatus, the instructions for executing the computer or other programmable data processing apparatuses by generating a computer-implemented process by performing a series of operations on the computer or other programmable data processing apparatuses may provide operations for executing the functions described in the flowchart block(s).

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the corresponding functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or may be further separated into additional components and “units”. Further, the components and “units” may be implemented to operate one or more CPUs in a device or a secure multimedia card.

Hereinafter, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing communication functions.

Furthermore, an embodiment of the disclosure may also be applied to other communication system having a technical background or channel form similar to an embodiment of the disclosure hereinafter described. Furthermore, an embodiment of the disclosure may also be applied to other communication system through some modifications in a range not greatly departing from the scope of the disclosure based on a decision of a person having skilled technical knowledge.

A term for identifying an access node, terms to denote network entities or network functions (NFs), terms to denote messages, a term to denote an interface between network entities, terms to denote various types of identification information, etc., which are used in the following description, have been exemplified for convenience of description. Accordingly, the disclosure is not limited to terms described later, and another term to denote a target having an equivalent technical meaning may be used.

Hereinafter, for convenience of description, some of terms and names defined in the 3rd generation partnership project long term evolution (3GPP LTE) standard may be used. However, the disclosure is not restricted by the terms and names, and may also be identically applied to systems that follow other standards. Hereinafter, embodiments of the disclosure will be described with reference to the accompanying drawings.

FIGS. 1A and 1B each illustrate a diagram of an example of an architecture of a mobile communication system using a split mobile communication base station (split RAN) according to an embodiment of the disclosure.

FIG. 1A illustrates a diagram of an example of an architecture of a typical split mobile communication system. An RAN node 20 illustrated in FIG. 1A may include a central unit (CU) and a distributed unit (DU) 26. The central unit (CU) may include a central unit-control plane (CU-CP) 22 and a central unit-user plane (CU-UP) 24 for processing data packets of a UE.

In an embodiment, the RAN Node 20, which is a base station, may include one CU-CP 22, and one or more CU-UPs 24 and one or more DUs 26 connected thereto, or may include other combinations thereof. The CU-CP 22, CU-UP 24 and DU 26 may separately support respective base station functions.

In an embodiment, the CU-CP 22 may support a radio resource control (RRC) layer that processes control signals to be transmitted to the UE, the CU-UP 24 may support a packet data convergence protocol (PDCP) that processes data packets of the UE, and the DU 26 may support a radio link control (RLC) layer, a medium access control (MAC) layer, and a physical (PHY) layer. An interface between base station internal functions, such as an F1 interface or a W1 interface, may be connected between the CU-CP 22 and CU-UP 24 and the DU 26. The F1 or W1 interface may include a F1-C and W1-C of a control plane for delivering control information and a F1-U and W1-U of a user plane for delivering user data information and PDCP status packets of the UE. The CU-CP 22 and CU-UP 24 may be connected to an interface between base station internal functions such as an E1 interface. Also, the RAN Node 20 may be connected to a core network (CN) 30 using an S1 or NG interface, and in a split RAN architecture, the CU-CP 22 may be connected to the CN 30 through an interface supporting the control plane, and the CU-UP 24 may be connected to the CN 30 through an interface supporting the user plane.

FIG. 1B illustrates a diagram of an example of an architecture of an eNB, which is a base station in a split mobile communication LTE system. The eNB, which is the LTE base station illustrated in FIG. 1B, may include an eNB-control plane (eNB-CP) 72 and an eNB-user plane (eNB-UP) 74. The eNB-CP 72 supports the functions of the CU-CP and DU of the RAN Node, and as an embodiment, may support a radio resource control (RRC) layer that processes control signals to be transmitted to the UE, and may support a radio link control (RLC) layer, a medium access control (MAC) layer, and a physical (PHY) layer.

The eNB-UP 74 supports the function of the CU-CP 22 of the RAN Node 20, and, in an embodiment, the eNB-UP 74 may support the packet data convergence protocol (PDCP) layer that processes data packets of the UE.

In an embodiment, a control plane E1 interface for delivering control information and an interface between base station internal functions, such as NR-U of a user plane for delivering user data information and PDCP status packets of the UE, may be connected between the eNB-CP 72 and the eNB-UP 74.

In addition, in an embodiment, the eNB 70 may be connected to an evolved packet core (EPC) 80, which is the core network of the LTE system, using the S1 interface, and in a split eNB architecture, the eNB-CP 72 may be connected to the mobility management entity (MME) 82 of the EPC 80 through the S1 interface supporting the control plane, and the eNB-UP 74 may be connected to a serving gateway (S-GW) 84 through the S1 interface supporting the user plane.

The disclosure may provide a method for configuring and operating a variety of versions of a protocol that performs data packet processing of a user terminal, such as packet data convergence protocol (PDCP), in entity or function that processes the data packet of the user terminal such as the CU-UP 24 in FIG. 1A or eNB-UP 74 in FIG. 1B.

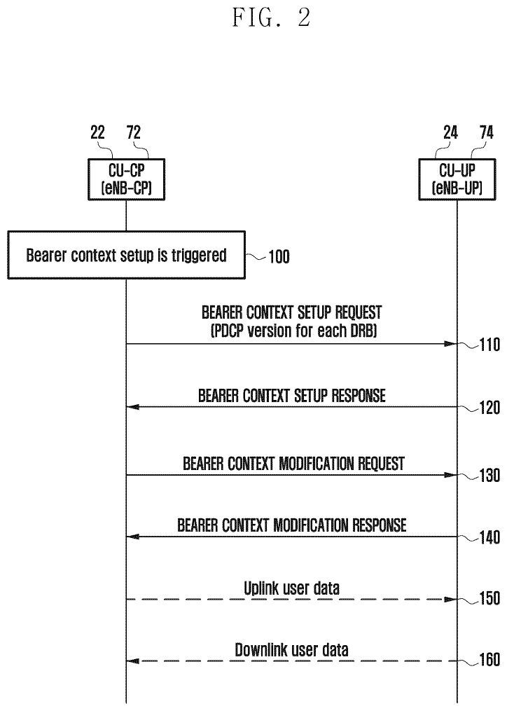

FIG. 2 illustrates a diagram of a signaling procedure performed with the CU-UP 24 or eNB-UP 74 to configure DRB for the UE in the CU-CP 22 or eNB-CP 72 according to an embodiment of the disclosure.

FIG. 2 illustrates an example in which a data radio bearer (DRB) is configured from the CU-CP 22 to the CU-UP 24 or from the eNB-CP 72 to the eNB-UP 74 so as to provide mobile communication services to the UE while providing a PDCP version to the corresponding DRB, so that in the CU-UP 24 or eNB-UP 74, the version of the protocol for processing the user data packet of the UE may be configured and used in the corresponding DRB according to an embodiment of the disclosure.

With reference to FIG. 2, when a procedure for starting DRB configuration for the UE is initiated in the CU-CP 22 or eNB-CP 72 in operation 100, the CU-CP 22 or eNB-CP 72 may transmit a message (e.g., BEARER CONTEXT SETUP REQUEST message) including DRB configuration information and the like to the CU-UP 24 or eNB-UP 74 in operation 110. The procedure for starting DRB configurations for the UE may be initiated by a bearer configuration request in a core network, a PDU session configuration request, a QoS flow configuration request, or the like, for example. In the process in which the UE moves to proceed a handover procedure, the DRB configuration procedure may start based on the information included in the handover request message received from a previous base station. The BEARER CONTEXT SETUP REQUEST message transmitted in operation 110 may be transmitted to configure one or more DRBs, and may include information related to DRB configurations for each DRB. PDCP version information may be included in the DRB configuration information, and the information may include protocol information for processing the operating version of the PDCP protocol or user data packet of the UE.

In operation 110, the CU-UP 24 or eNB-UP 74, which has received the BEARER CONTEXT SETUP REQUEST message from the CU-CP 22 or eNB-CP 72, may configure a protocol for processing the PDCP or user data packet of the UE to be used according to the PDCP version information included while performing configurations necessary for DRB support in the CU-UP 24 or eNB-UP 74 by using the information included in the BEARER CONTEXT SETUP REQUEST message. If the BEARER CONTEXT SETUP REQUEST message does not include PDCP version information, it may be configured to use a protocol for processing a previously predetermined PDCP version or user data packet of the UE.

The CU-UP 24 or eNB-UP 74 responds by transmitting a response message (e.g., BEARER CONTEXT SETUP RESPONSE message) to the CU-CP 22 or eNB-CP 72 in operation 120. The response message may include response information about DRB configurations.

In operation 130, the CU-CP 22 or eNB-CP 72 may transmit, to the CU-UP 24 or eNB-UP 74, a message (e.g., BEARER CONTEXT MODIFICATION REQUEST message) including downlink tunnel information of F1-U or W1-U or X2-U or Xn-U or NR-U for the UE's user data packet and PDCP status packet transmission in the CU-UP 24 or eNB-UP 74.

In operation 140, the CU-UP 24 or eNB-UP 74 may respond to the CU-UP 22 or eNB-CP 72 by transmitting a response message (e.g., BEARER CONTEXT MODIFICATION RESPONSE message) to the message in operation 130.

In the subsequent operations 150 and 160, the delivery of the user data packets and PDCP status packets of the UE between the CU-CP 22 or eNB-CP 72 and the CU-UP 24 or eNB-UP 74 is initiated.

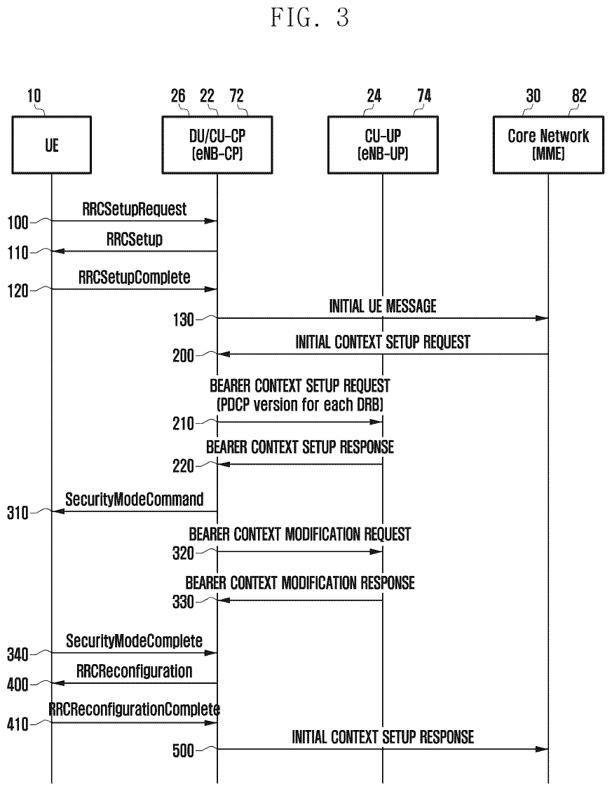

FIG. 3 illustrates a diagram of an example related to configuring various PDCP versions through a signaling procedure between the CU-CP 22 or eNB-CP 72 and the CU-UP 24 or eNB-UP 74 and the UE and core network according to an embodiment of the disclosure.

FIG. 3 illustrates an example of a series of procedures including a procedure from the UE to the core network in which a data radio bearer (DRB) is configured from the CU-CP 22 to the CU-UP 24 or from the eNB-CP 72 to the eNB-UP 74 so as to provide mobile communication services to the UE while providing a PDCP version to the corresponding DRB, so that in the CU-UP 24 or eNB-UP 74, the version of the protocol for processing the user data packet of the UE may be configured and used in the corresponding DRB according to an embodiment of the disclosure.

The CU-CP 22 or eNB-CP 72 uses a control message (RRC message) transmitted to the UE to deliver the PDCP version information used by the corresponding DRB to the UE. As a result, it may match the protocol for processing the user data packet of the UE between the UE and the base station, thereby preventing the operation error that may be caused by the protocol mismatch.

With reference to FIG. 3, in operation 100, a UE 10 may transmit a RRC setup request message (e.g., RRCSetupRequest message) to a base station. The RRC message transmitted by the UE 10 may be transmitted to the CU-CP 22 via the DU 26. In the case of a split eNB base station, the RRC message transmitted by the UE 10 may be directly transmitted to the eNB-CP 72.

In operation 110, the CU-CP 22 or eNB-CP 72 may perform the connection establishment procedure of the corresponding UE 10 by transmitting an RRC configuration message (e.g., RRCSetup message) to the UE. The RRC message transmitted by the CU-CP 22 may be transmitted to the UE 10 via the DU 26. In the case of the split eNB base station, the RRC message transmitted by the eNB-CP 72 may be transmitted to the UE 10.

The UE 10, which has received the RRC configuration message in operation 110, may respond by transmitting a RRC configuration complete message (e.g., RRCSetupComplete message) in operation 120.

The CU-CP 22 or eNB-CP 72, which has received the RRC configuration complete message from the UE 10, may transmit, to the core network 30 or 82, a message (e.g., INITIAL UE MESSAGE message) including information about an identity related to the UE for initial network establishment, etc., through the S1 or NG interface, in operation 130. In the LTE system, the eNB-CP 72 may transmit the INITIAL UE MESSAGE message to the MME 82.

In operation 200, the core network 30 or 82 may transmit a message (e.g., INITIAL CONTEXT SETUP REQUEST message) including configuration information for the user data service of the UE to the CU-CP 22 or eNB-CP 72. The INITIAL CONTEXT SETUP REQUEST message may include a bearer configuration request information, PDU session configuration request information, QoS flow configuration request information, or the like.

In operation 200, the CU-CP 22 or eNB-CP 72 may determine the DRB configuration information on the basis of the bearer configuration requestion information, PDU session configuration request information, QoS flow configuration request information, or the like, received from the core network 30 or 82, and may perform the procedure for the DRB configuration.

In operation 210, the CU-CP 22 or eNB-CP 72 may transmit a message (e.g., BEARER CONTEXT SETUP REQUEST message) including the DRB configuration information, etc. to the CU-UP 24 or eNB-UP 74.

The BEARER CONTEXT SETUP REQUEST message transmitted in operation 210 may be transmitted to configure one or more DRBs, and may include information related to DRB configurations for each DRB. PDCP version information may be included in the DRB configuration information, which may include protocol information for processing the PDCP protocol operating version or user data packet of the UE.

In operation 210, the CU-UP 24 or eNB-UP 74, which has received the BEARER CONTEXT SETUP REQUEST message from the CU-CP 22 or eNB-CP 72, may configure a protocol for processing the PDCP or user data packet of the UE to be used according to the PDCP version information included while performing configurations necessary for DRB support in the CU-UP 24 or eNB-UP 74 by using the information included in the BEARER CONTEXT SETUP REQUEST message. In case that the BEARER CONTEXT SETUP REQUEST message does not include PDCP version information, it may be configured to use a protocol for processing a previously predetermined PDCP version or user data packet of the UE.

In operation 220, the CU-UP 24 or eNB-UP 74 may respond by transmitting a message (e.g., BEARER CONTEXT SETUP RESPONSE message) including a response information about DRB configuration to the CU-CP 22 or eNB-CP 72.

In operations 310 and 340, the CU-CP 22 or eNB-CP 72 may exchange a message related to security configuration (e.g., SecurityModeCommand message and SecurityModeComplete message) with the UE 10 and perform security related configuration to be used between the UE and the base station.

In operation 320, the CU-CP 22 or eNB-CP 72 may transmit, to the CU-UP 24 or eNB-UP 74, a message (e.g., BEARER CONTEXT MODIFICATION REQUEST message) including downlink tunnel information of F1-U or W1-U or X2-U or Xn-U or NR-U for the UE's user data packet and PDCP status packet transmission in the CU-UP 24 or eNB-UP 74.

In operation 330, the CU-UP 24 or eNB-UP 74 may respond to the CU-UP 22 or eNB-CP 72 by transmitting a response message (e.g., BEARER CONTEXT MODIFICATION RESPONSE message) to the message in operation 320.

Thereafter, in operation 400, the CU-CP 22 or eNB-CP 72 may transmit, to the UE 10, an RRC connection reconfiguration message (e.g., RRCReconifguration message) including the DRB configuration information, etc. for the user data service of the UE. In operation 410, the UE may transmit the RRC connection reconfiguration complete message (e.g., RRCReconifgurationComplete message) to the CU-CP 22 or eNB-CP 72.

The CU-CP 22 or eNB-CP 72, which has received the RRC connection reconfiguration complete message (e.g., RRCReconifgurationComplete message) from the UE in operation 410, may transmit, to the core network 30 or 82, a response message (e.g. INITIAL CONTEXT SETUP RESPONSE message) including a processing result such as the UE's context configurations and requested bearers or QoS flow configuration requests in operation 500.

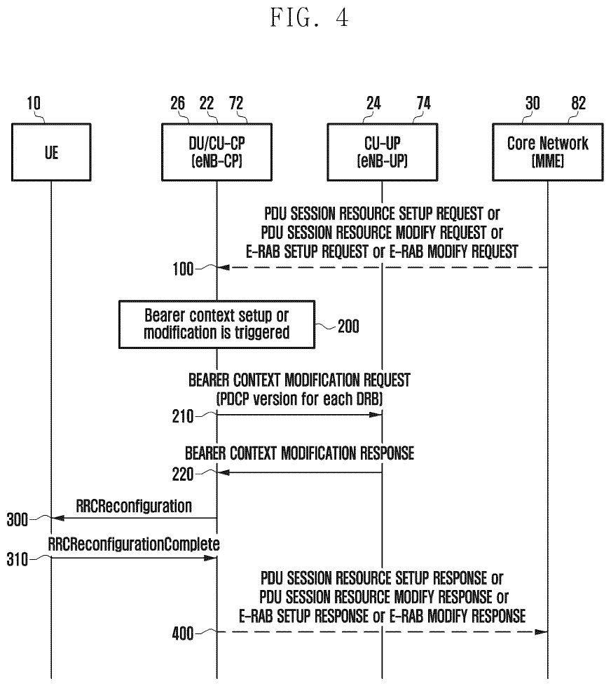

FIG. 4 illustrates an example of a series of procedures including a procedure from the UE to the core network in which a data radio bearer (DRB) is configured or modified from the CU-CP 22 to the CU-UP 24 or from the eNB-CP 72 to the eNB-UP 74 so as to provide mobile communication services to the UE while also providing a PDCP version for the corresponding DRB, and thus, in the CU-UP 24 or eNB-UP 74, the version of the protocol for processing user data packets of the UE may be configured and used in the corresponding DRB according to an embodiment of the disclosure.

The CU-CP 22 or eNB-CP 72 may deliver PDCP version information used in the corresponding DRB to the UE using a control message (e.g., RRC message) transmitted to the UE, which makes it possible to match the protocols for processing user data packets of the UE between the UE and the base station, thereby preventing operation errors that may occur due to protocol mismatch.

With reference to FIG. 4, in operation 200, the CU-CP 22 or eNB-CP 72 may determine and start a procedure for configuring an additional DRB to the UE or changing the configuration information of the already configured DRB.

The additional configuration of the DRB for the UE or modification of the configuration information of the already configured DRB by the CU-CP 22 or eNB-CP 72 in operation 200 may be determined, as in operation 100, by a request to add or modify a PDU session in the core network 30 or 82, a request to add or modify a QoS flow, or a request to add or modify a bearer, etc. In addition, in case that it is necessary to modify resources or configurations for the DRB at the base station, it may be determined at the discretion of the CU-CP 22 or eNB-CP 72, determined by the request of operation and management (OAM) or due to other reasons.

When the CU-CP 22 or eNB-CP 72 starts a procedure to additionally configure the DRB to the UE or modify the configuration information of the already configured DRB in operation 200, the CU-CP 22 or eNB-CP 72 may transmit a message (e.g., BEARER CONTEXT MODIFICATION REQUEST message) including the DRB configuration information and the like to the CU-UP 24 to eNB-UP 74 in operation 210.

The BEARER CONTEXT MODIFICATION REQUEST message transmitted in operation 210 may be transmitted to configure one or more DRBs, and may include information related to DRB configurations for each DRB. The DRB configuration information may include PDCP version information, and this information may include the operating version of the PDCP protocol or protocol information for processing user data packets of the UE. In operation 210, the CU-UP 24 or eNB-UP 74, which has received the BEARER CONTEXT MODIFICATION REQUEST message from the CU-CP 22 or eNB-CP 72, uses the information included in the BEARER CONTEXT MODIFICATION REQUEST message to perform the necessary configurations for DRB support in the CU-UP 24 or eNB-UP 74, and may configure the protocol for processing the PDCP or user data packet of the UE to be used according to the included PDCP version information.

In case that the BEARER CONTEXT MODIFICATION REQUEST message does not include PDCP version information, it may be configured to use a pre-determined PDCP version or a protocol for processing user data packets of the UE.

In operation 220, the CU-UP 24 or eNB-UP 74 may respond by transmitting a message (e.g., BEARER CONTEXT MODIFICATION RESPONSE message) including response information for DRB configurations, etc. to the CU-CP 22 or eNB-CP 72.

Thereafter, in operation 300, the CU-CP 22 or eNB-CP 72 may transmit an RRC connection reconfiguration message (e.g., RRCReconifguration message) including the DRB configuration information for the user data service of the UE to the UE 10.

In operation 310, the UE may transmit an RRC connection reconfiguration complete message (e.g., RRCReconifgurationComplete message) to the CU-CP 22 or the eNB-CP 72.

In case that the CU-CP 22 or eNB-CP 72 receives a request to add or modify a PDU session, a request to add or modify QoS flow, or a request to add or modify a bearer from the core network 30 or 82 in operation 100, the CU-CP 22 or eNB-CP 72 may transmit a response message to the core network 30 or 82 in operation 400.

For each DRB, the PDCP version information may be added to the bearer configuration request message (e.g., BEARER CONTEXT SETUP REQUEST message) and bearer modification request message (e.g., BEARER CONTEXT MODIFICATION REQUEST message) transmitted from the CU-CP 22 or eNB-CP 72 to the CU-UP 24 or eNB-UP 74, which are used in operation 110 in FIG. 2, operation 210 in FIG. 3, and operation 210 in FIG. 4. The PDCP version information may include protocol information or PDCP version information for processing user data packets of the terminal in the CU-UP 24 or eNB-UP 74. Examples of PDCP version information may include at least one of the following.
NR PDCP (Packet Data Convergence Protocol)
E-UTRA PDCP (Packet Data Convergence Protocol)
WiFi
Ethernet
IP (Internet Protocol)

The PDCP version information may be added as an extension of a radio access technology (RAT) used between the UE and the mobile communication base station and the services provided.

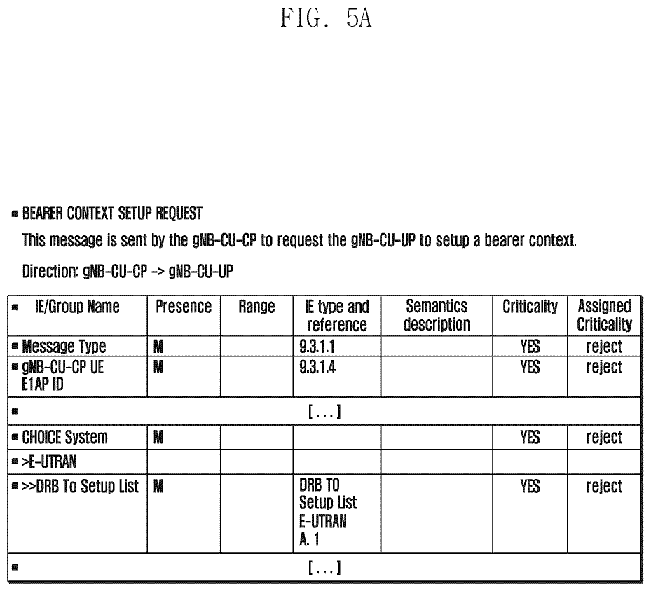

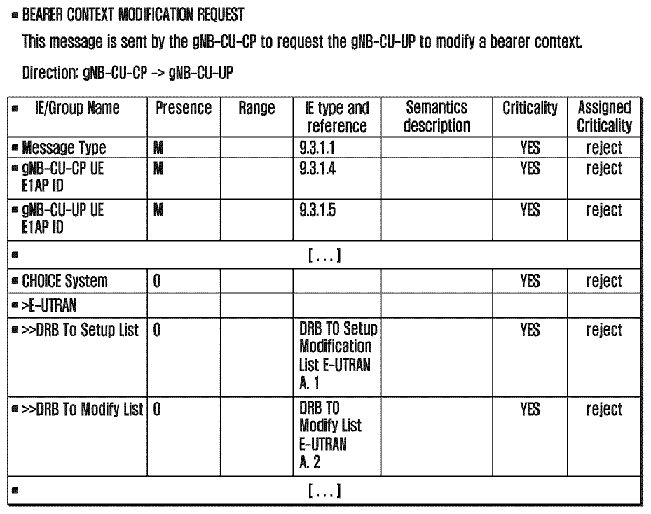

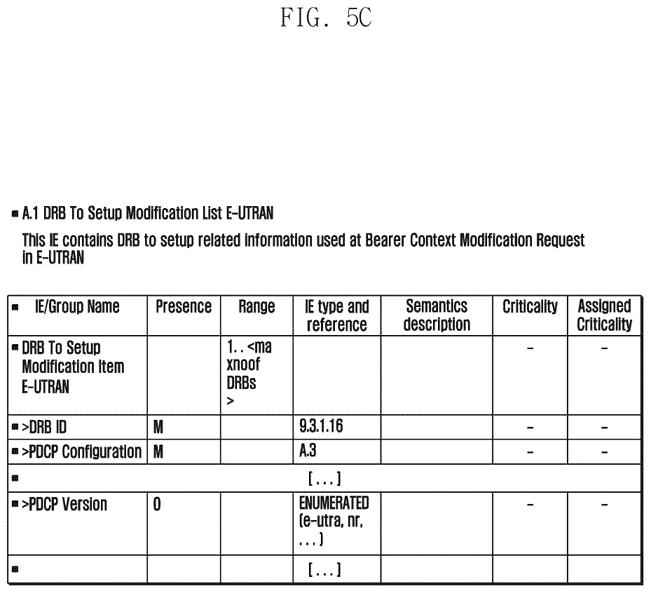

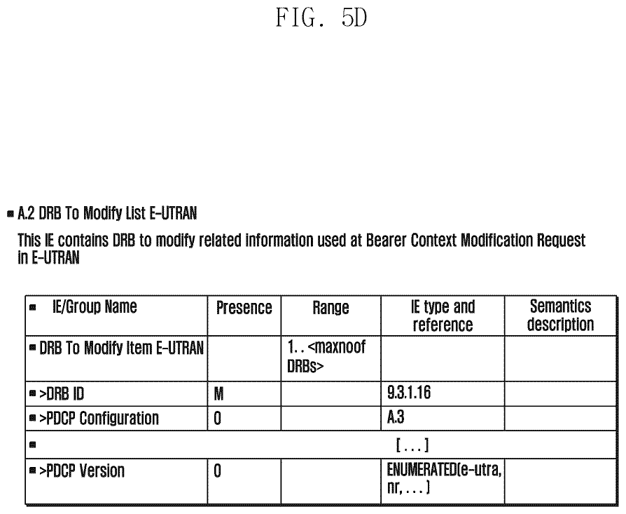

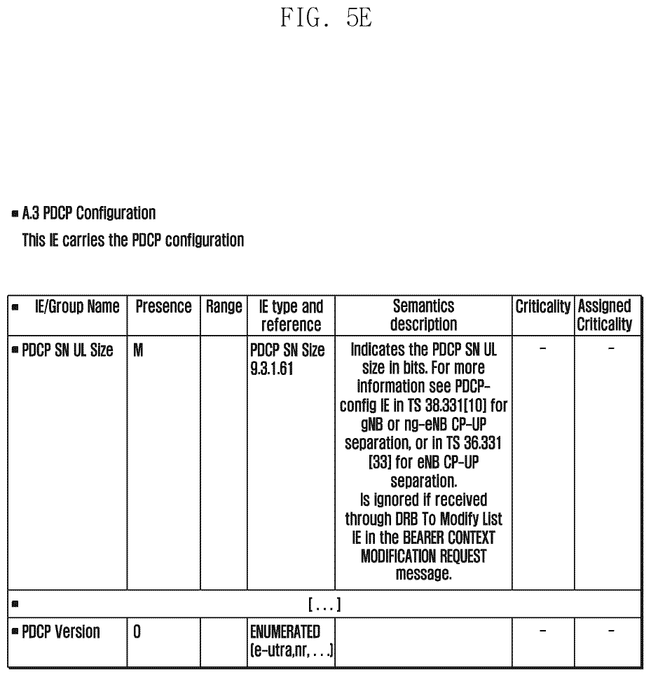

FIGS. 5A to 5E each illustrate an example of configuring one message including, for each DRB, PDCP version information in the bearer configuration request message (e.g., BEARER CONTEXT SETUP REQUEST message) and bearer modification request message (e.g., BEARER CONTEXT MODIFICATION REQUEST message) transmitted from the CU-CP 22 or eNB-CP 72 to the CU-UP 24 or eNB-UP 74, which are used in operation 110 in FIG. 2, operation 210 in FIG. 3, and operation 210 in FIG. 4, according to an embodiment of the disclosure.

The configuration example in FIG. 5 illustrates a configuration example in which only NR PDCP or E-UTRA PDCP information is included in the PDCP version information for each DRB in the eNB, which is an LTE base station, and the information that may be included in the PDCP version may be added.

FIG. 5A illustrates a configuration example of a BEARER CONTEXT SETUP REQUEST message, exemplified as a bearer configuration request message. The BEARER CONTEXT SETUP REQUEST message may include DRB To Setup List IE information, which includes DRB information to be newly configured for the case in which the evolved UMTS terrestrial access network (E-UTRAN) system, which refers to the LTE system, is used. FIG. 5B illustrates a configuration example of the BEARER CONTEXT MODIFICATION REQUEST message, exemplified by the bearer modification request message. The BEARER CONTEXT MODIFICATION REQUEST message may include DRB To Setup List IE information that includes DRB information to be newly configured for a case in which the evolved UMTS terrestrial access network (E-UTRAN) system, which refers to the LTE system, is used, and DRB To Modify List IE information to modify the configuration information of the already configured DRB.

The DRB To Setup List IE illustrated and included in FIGS. 5A and 5B may be configured in the form of a DRB To Setup Modification List E-UTRAN IE as illustrated in FIG. 5C.

The DRB To Setup Modification List E-UTRAN IE in FIG. 5C may include DRB information to be newly configured, the DRB information may include the DRB ID IE used to distinguish DRBs, and the DRB information may also include PDCP Configuration IE information including PDCP configuration information. The PDCP configuration IE may be configured as illustrated in FIG. 5E, and PDCP Version IE to support one embodiment.

A PDCP Version IE for supporting an embodiment may be included. In addition, as another method of including PDCP version information, the DRB To Setup Modification List E-UTRAN IE in FIG. 5C may be configured to include PDCP Version IE for each DRB.

The PDCP Version IE may include the value of ‘e-utra’ or ‘nr’ and may refer to the E-UTRA (LTE) PDCP and NR PDCP versions, respectively. In addition, the PDCP Version IE may be expanded to include other PDCP versions or protocol information.

The DRB To Modify List IE included and illustrated in FIG. 5B may be configured in the form of a DRB To Modify List E-UTRAN IE as illustrated in FIG. 5D.

The DRB To Modify List E-UTRAN IE illustrated in FIG. 5D may include modified DRB configuration information of the previously configured DRB. The DRB information may include DRB ID IE used to distinguish DRBs, and the DRB information may also include PDCP configuration IE information including the PDCP configuration information.

The PDCP configuration IE may be configured as illustrated in FIG. 5E and may include PDCP Version IE to support one embodiment.

In addition, as another method of including PDCP version information, the DRB To Modify List E-UTRAN IE illustrated in FIG. 5D may be configured to include PDCP Version IE for each DRB. The PDCP version IE may include the value of ‘e-utra’ or ‘nr’ and may refer to the E-UTRA (LTE) PDCP and NR PDCP versions, respectively. In addition, the PDCP Version IE may be expanded to include other PDCP versions or protocol information.

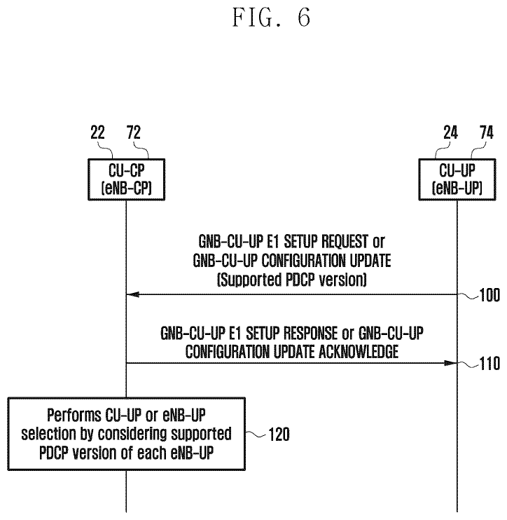

FIG. 6 illustrates an example of a procedure in which the CU-UP 24 or eNB-UP 74 delivers, to the CU-CP 22 or eNB-CP 72, the protocol version for processing the user data packet of the UE supported by the CU-UP 24 or eNB-UP 74, for example, PDCP version information, and thus, the protocol version may be used in the CU-CP 22 or eNB-CP 72 to configure the DRB for processing the user data packets of the UE or to select the CU-CP 22 or eNB-CP 72, according to an embodiment of the disclosure.

In operation 100 in FIG. 6, in the process in which the CU-UP 24 or eNB-UP 74 establishes a connection to the CU-CP 22 or eNB-CP 72, or the modified configuration information from the CU-UP 24 or eNB-UP 74 is delivered to the CU-CP 22 or eNB-CP 72, the PDCP version information supported by the CU-UP 24 or eNB-UP 74 may be delivered to the CU-CP 22 or eNB-CP 72.

In case of establishing a connection to the CU-CP 22 or eNB-CP 72, the CU-UP 24 or eNB-UP 74 transmits, to the CU-CP 22 or eNB-CP 72, an E1 connection establishment request message (e.g., GNB-CU-UP E1 SETUP REQUEST message), and include the PDCP version information supported by the CU-UP 24 or eNB-UP 74 in the E1 connection establishment request message (e.g., GNB-CU-UP E1 SETUP REQUEST message).

In case of delivering the modified configuration information from the CU-UP 24 or eNB-UP 74 to the CU-CP 22 or eNB-CP 72, while transmitting the CU-UP/eNB-UP configuration information update message (e.g., GNB-CU-UP CONFIGURATION UPDATE message), the PDCP version information supported by the CU-UP 24 or eNB-UP 74 may be included in the CU-UP/eNB-UP configuration information update message (e.g., GNB-CU-UP CONFIGURATION UPDATE message).

In operation 110, the CU-CP 22 or eNB-CP 72 may transmit a response message (e.g., GNB-CU-UP E1 SETUP RESPONSE message or GNB-CU-UP CONFIGURATION UPDATE ACKNOWLEDGE message) to the CU-UP 24 or eNB-UP 74.

In operation 120, in case of configuring the DRB to process the user data packet of the UE or selecting the CU-UP 24 or eNB-UP 74 to process the user data packet of the UE, the PDCP version supported by the CU-UP 24 or eNB-UP 74 may be considered.

The PDCP version information supported by the CU-UP 24 or eNB-UP 74 may be included in the E1 connection establishment request message (e.g., GNB-CU-UP E1 SETUP REQUEST message) transmitted from the CU-UP 24 or eNB-UP 74 to the CU-CP 22 or eNB-CP 72 and the CU-UP/eNB-UP configuration information update message (e.g., GNB-CU-UP CONFIGURATION UPDATE message), used in operation 100 in FIG. 6. Examples of supported PDCP version information may include at least one of the following.
NR PDCP (Packet Data Convergence Protocol)
E-UTRA PDCP (Packet Data Convergence Protocol)
WiFi
Ethernet
IP (Internet Protocol)

In addition, the CU-UP 24 or eNB-UP 74 may support one or more PDCP versions, and in this case, it may include information about the PDCP versions to be supported in the form of a list, or may indicate in the form of ‘all’ and ‘both’ that various types of PDCP versions may be supported. The PDCP version information supported by the CU-UP 24 or eNB-UP 74 may be added as an extension of the radio access technology (RAT) used between the UE and the mobile communication base station and the services provided.

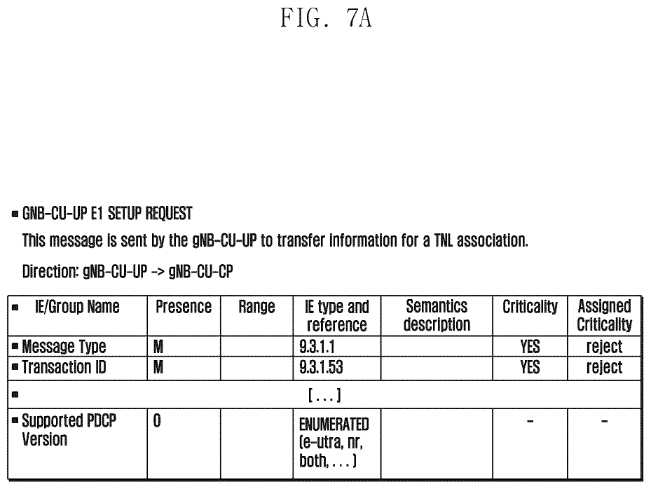

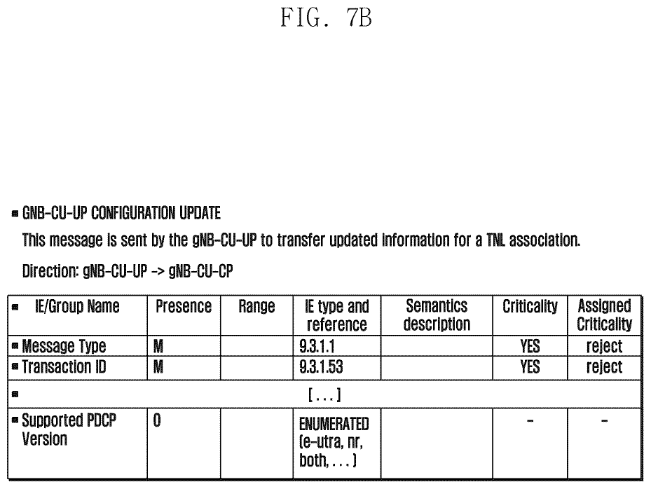

FIGS. 7A and 7B each illustrate a configuration example of one message including the supported PDCP version information in the E1 connection establishment request message (e.g., GNB-CU-UP E1 SETUP REQUEST message) transmitted from the CU-UP 24 or eNB-UP 74 to the CU-CP 22 or eNB-CP 72 and the CU-UP/eNB-UP configuration information update message (e.g., GNB-CU-UP CONFIGURATION UPDATE message), used in operation 100 in FIG. 6, according to an embodiment of the disclosure.

FIG. 7A illustrates a configuration example of the GNB-CU-UP E1 SETUP REQUEST message, exemplified as the E1 connection establishment request message. The GNB-CU-UP E1 SETUP REQUEST message may include the supported PDCP version IE information including the PDCP version information supported by the CU-UP 24 or eNB-UP 74.

FIG. 7B illustrates a configuration example of the GNB-CU-UP CONFIGURATION UPDATE message, exemplified as the CU-UP/eNB-UP configuration information update message. The GNB-CU-UP CONFIGURATION UPDATE message may include supported PDCP version IE information including PDCP version information supported by the CU-UP 24 or eNB-UP 74. The supported PDCP version IE may include the value of ‘e-utra’ or ‘nr’ and may refer to the E-UTRA (LTE) PDCP and NR PDCP versions, respectively. In addition, in an embodiment of the disclosure related to FIG. 7, the value of ‘both’ may be included in the supported PDCP version IE, and this case may indicate that the CU-UP 24 or eNB-UP 74 supports both the E-UTRA (LTE) PDCP and NR PDCP versions. In addition, the supported PDCP version IE may be extended to include other PDCP versions or protocol information.

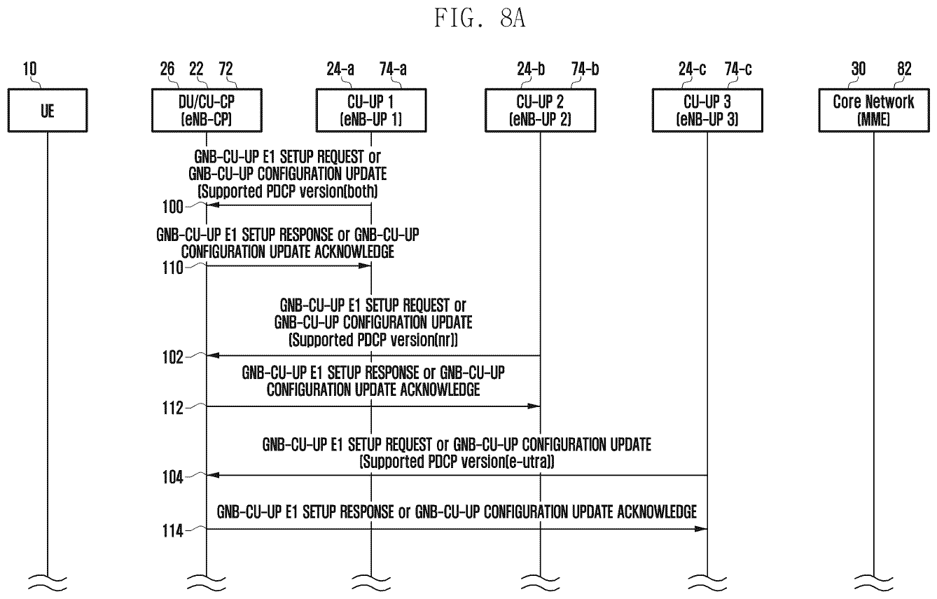

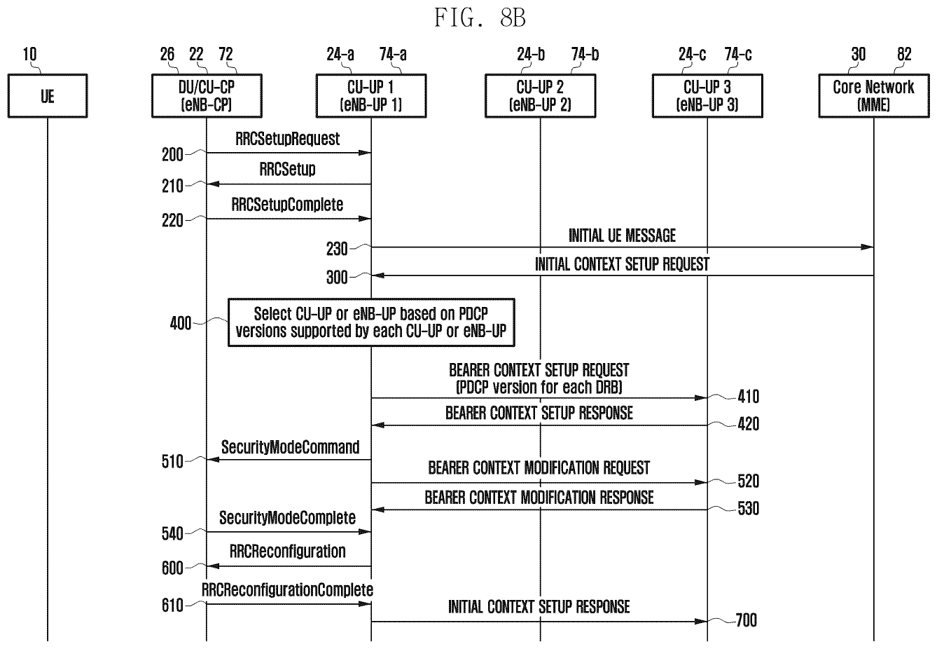

FIGS. 8A and 8B each illustrate an example of a series of procedures including a procedure from the UE to the core network 30 or 82 in which the CU-UP 24 or eNB-UP 74 delivers, to the CU-CP 22 or eNB-CP 72, a protocol version for processing the user data packet of the UE supported by the CU-UP 24 or eNB-UP 74, for example, PDCP version information, and the protocol version is used to configure the DRB for processing the user data packet of the UE in the CU-CP 22 or eNB-CP 72 or select the CU-UP 24 or eNB-UP 74, and a data radio bearer (DRB) is configured from the CU-CP 22 to the CU-UP 24 or from the eNB-CP 72 to the eNB-UP 74 so as to provide mobile communication services to the UE while providing the PDCP version to the corresponding DRB, so that in the CU-UP 24 or eNB-UP 74, the version of the protocol for processing the user data packet of the UE may be configured and used in the corresponding DRB, according to an embodiment of the disclosure.

In operations 100, 102, and 104 in FIG. 8, in the process in which each CU-UP 24 or eNB-UP 74 establishes a connection to the CU-CP 22 or eNB-CP 72, or the modified configuration information from the CU-UP 24 or eNB-UP 74 is delivered to the CU-CP 22 or eNB-CP 72, the PDCP version information supported by the CU-UP 24 or eNB-UP 74 may be delivered to the CU-CP 22 or eNB-CP 72.

In case of establishing a connection to the CU-CP 22 or eNB-CP 72, the CU-UP 24 or eNB-UP 74 transmits, to the CU-CP 22 or eNB-CP 72, an E1 connection establishment request message (e.g., GNB-CU-UP E1 SETUP REQUEST message), and include the PDCP version information supported by the CU-UP 24 or eNB-UP 74 in the E1 connection establishment request message (e.g., GNB-CU-UP E1 SETUP REQUEST message).

In case of delivering the modified configuration information from the CU-UP 24 or eNB-UP 74 to the CU-CP 22 or eNB-CP 72, while transmitting the CU-UP/eNB-UP configuration information update message (e.g., GNB-CU-UP CONFIGURATION UPDATE message), the PDCP version information supported by the CU-UP 24 or eNB-UP 74 may be included in the CU-UP/eNB-UP configuration information update message (e.g., GNB-CU-UP CONFIGURATION UPDATE message).

An embodiment may be illustrated in which a CU-UP 1 24-a or eNB-UP 1 74-a may support both E-UTRA (LTE) PDCP and NR PDCP versions, a CU-UP 2 24-b or eNB-UP 2 74-b may support only the NR PDCP version, and a CU-UP 3 24-c or eNB-UP 3 74-c may support only the E-UTRA (LTE) PDCP version.

In operations 110, 112, and 144, the CU-CP 22 or eNB-CP 72 may transmit a response message (e.g., GNB-CU-UP E1 SETUP RESPONSE message or GNB-CU-UP CONFIGURATION UPDATE ACKNOWLEDGE message) to the CU-UP 24 or eNB-UP 74, respectively. Thereafter, in case of configuring a DRB to process the user data packet of the UE or selecting the CU-UP 24 or eNB-UP 74 to process the user data packet of the UE, the PDCP version supported by the CU-UP 24 or eNB-UP 74 may be considered.

In operation 200, the UE 10 may transmit an RRC Setup request message (e.g., RRCSetupRequest message) to the base station. The RRC message transmitted by the UE 10 may be transmitted to the CU-CP 22 via the DU 26. In the case of a split eNB base station, the RRC message transmitted by the UE 10 may be directly transmitted to the eNB-CP 72.

In operation 210, the CU-CP 22 or eNB-CP 72 may perform a connection establishment procedure for the UE 10 by transmitting the RRC setup message (e.g., RRCSetup message) to the UE. The RRC message transmitted by the CU-CP 22 may be transmitted to the UE 10 via the DU 26. In the case of the split eNB base station, the RRC message transmitted by the eNB-CP 72 may be transmitted to the UE 10.

In operation 220, the UE 10, which has received the RRC configuration message in operation 210 may respond by transmitting an RRC configuration complete message (e.g., RRCSetupComplete message).

In operation 230, the CU-CP 22 or eNB-CP 72, which has received the RRC configuration complete message from the UE 10, may transmit, to the core network 30 or 82, a message including information about identity related to the UE for initial network connection (e.g., INITIAL UE MESSAGE message), etc., through the S1 or NG interface. In the LTE system, the eNB-CP 72 may transmit an INITIAL UE MESSAGE message to the MME 82.

In operation 300, the core network 30 or 82 may transmit a message (e.g., INITIAL CONTEXT SETUP REQUEST message) including configuration information for the user data service of the UE to the CU-CP 22 or eNB-CP 72. The INITIAL CONTEXT SETUP REQUEST message may include bearer configuration request information, PDU session configuration request information, QoS flow configuration request information, or the like.

In operation 300, the CU-CP 22 or eNB-CP 72 may determine DRB configuration information based on information received from the core network 30 or 82 such as bearer configuration request information or QoS flow configuration request information, and may perform a procedure for configuring the DRB.

In consideration of the PDCP version, etc. supported by each CU-UP 24 or eNB-UP 74 transmitted from each CU-UP 24 or eNB-UP 74 in operations 100, 102, and 104, the CU-UP 24 or eNB-UP 74 to process the corresponding DRB may be selected in operation 400.

Regarding an embodiment, it is illustrated in which NR PDCP is used to support the corresponding DRB, and a CU-UP 2 24-b or eNB-UP 2 74-b is selected in operation 400 for processing the corresponding DRB.

In operation 410, the CU-CP 22 or eNB-CP 72 may transmit a BEARER CONTEXT SETUP REQUEST message, illustrated as a message including DRB configuration information, etc., to the selected a CU-UP 2 24-b or eNB-UP 2 74-b. The BEARER CONTEXT SETUP REQUEST message transmitted in operation 410 may be transmitted to configure one or more DRBs, and may include information related to DRB configurations for each DRB. The DRB configuration information may include PDCP version information, and this information may include the operating version of the PDCP protocol or protocol information for processing the user data packets of the UE.

In operation 410, the CU-UP 2 24-b or eNB-UP 2 74-b, which has received the BEARER CONTEXT SETUP REQUEST message from the CU-CP 22 or eNB-CP 72, may configure a protocol for processing the PDCP or user data packet of the UE to be used according to the included PDCP version information while performing the configurations necessary for DRB support in the CU-UP 2 24-b or eNB-UP 2 74-b using the information included in the BEARER CONTEXT SETUP REQUEST message. In case that the PDCP version information is not included in the BEARER CONTEXT SETUP REQUEST message, it may be configured to use a pre-determined PDCP version or a protocol for processing the user data packets of the UE, and in an embodiment, even if the PDCP version information is not included, since the CU-UP 2 24-b or eNB-UP 2 74-b supports only the NR PDCP version, the corresponding DRB may be supported through NR PDCP. The CU-UP 2 24-b or eNB-UP 2 74-b may respond by transmitting a BEARER CONTEXT SETUP RESPONSE message to the CU-CP 22 or eNB-CP 72 in operation 420, and the response information about DRB configuration may be included.

In operations 510 and 540, the CU-CP 22 or eNB-CP 72 may exchange security configuration related messages (e.g., SecurityModeCommand message and SecurityModeComplete message) with the UE 10 and perform security related configuration to be used between the UE and the base station.

In operation 520, the CU-CP 22 or eNB-CP 72 may transmit, to the CU-UP 2 24-b or eNB-UP 2 74-b, a message (e.g., BEARER CONTEXT MODIFICATION REQUEST message) including downlink tunnel information of F1-U or W1-U or X2-U or Xn-U for the UE's user data packet and PDCP status packet transmission in the CU-UP 2 24-b or eNB-UP 2 74-b.

In operation 530, the CU-UP 2 24-b or eNB-UP 2 74-b may respond by transmitting a response message (e.g., BEARER CONTEXT MODIFICATION RESPONSE message) to the CU-CP 22 or eNB-CP 72.

In operation 600, the CU-CP 22 or eNB-CP 72 may transmit an RRC connection reconfiguration message (e.g., RRCReconifguration message) including DRB configuration information, etc. for the user data service of the UE to the UE 10.

In operation 610, the UE may transmit an RRC connection reconfiguration complete message (e.g., RRCReconifgurationComplete message) to the CU-CP 22 or the eNB-CP 72.

The CU-CP 22 or eNB-CP 72, which has received an RRC connection reconfiguration completion message (e.g., RRCReconifgurationComplete message) from the UE in operation 610, may transmit, to the core network 82 or 30, a response message (e.g., INITIAL CONTEXT SETUP RESPONSE message) including processing results such as requested context configuration of the UE and requested bearer or PDU session or QoS flow configuration request, in operation 700.

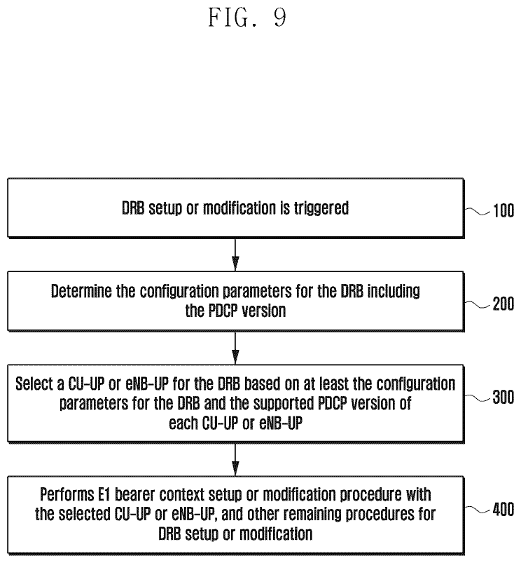

FIG. 9 illustrates a flowchart of a procedure for configuring or changing DRB within the CU-CP 22 or eNB-CP 72 according to an embodiment of the disclosure.

In operation 100, the DRB configuration or changing factor may occur. The DRB configuration or DRB configuration modification for the UE may occur by a request to add or modify a PDU session, or a request to add or modify a QoS flow, or a request to add or modify a bearer, etc. in the core network 30 or 82. In addition, in case that a modification in resources or configurations for DRB at the base station is required, it may be determined and proceeded at the discretion of the CU-CP or eNB-CP, or by a request of operation and management (OAM) or by other reasons.

In operation 200, the CU-CP 22 or eNB-CP 72 may determine the DRB configuration information of the UE, and the DRB configuration information may include the PDCP version to be used in the corresponding DRB.

In operation 300, the CU-CP 22 or eNB-CP 72 may use at least of PDCP version information and information that may be supported by each CU-UP 24 or eNB-UP 74 selectable by the CU-CP or eNB-CP to select the CU-UP 24 or eNB-UP 74 for processing the corresponding DRB. For example, the following method may be used to obtain PDCP version information supportable by each CU-UP 24 or eNB-UP 74 in the CU-CP 22 or eNB-CP 72. Alternatively, other methods may be used.
Received during the connection process (E1 setup) between the CU-CP 22 or eNB-CP 72 and the CU-UP 24 or eNB-UP 74
When changing configuration information in the CU-UP 24 or eNB-UP 74, it is received during the configuration information modification delivery process (CU-UP configuration update)
Configured by operation and management (OAM) etc.

After selecting the CU-UP 24 or eNB-UP 74 for processing the corresponding DRB in the CU-CP 22 or eNB-CP 72, in operation 300, in operation 400, a bearer context configuration procedure (E1 bearer context setup procedure) or bearer context modification procedure (E1 bearer context modification procedure) is performed with the CU-UP 24 or eNB-UP 74 selected to configure or modify the corresponding DRB. In addition, existing remaining procedures for configuring or modifying the DRB may be performed.

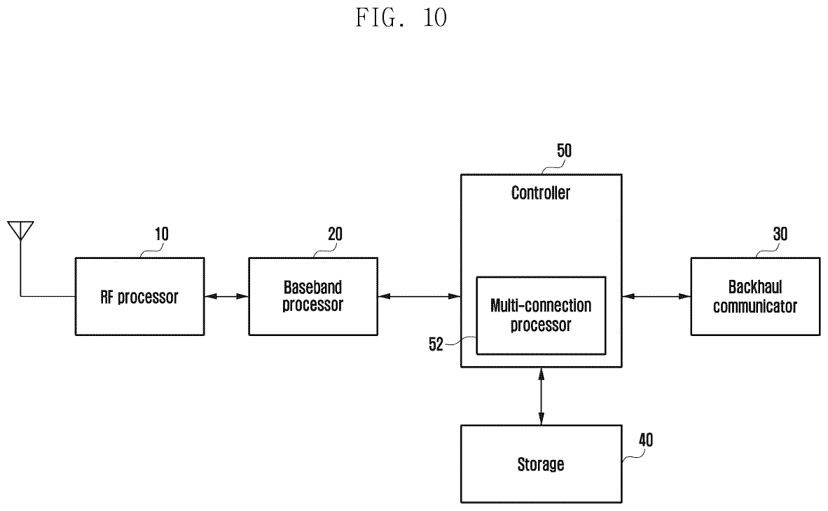

FIG. 10 illustrates a block diagram of an example of a structure of a base station (RAN Node, eNB, or gNB, etc.) according to an embodiment of the disclosure.

With reference to FIG. 10, the RAN node or eNB is configured to include an RF processor 10, a baseband processor 20, a backhaul communicator 30, a storage 40, and a controller 50. In case that the RAN node is split into a central unit (CU) and a distributed unit (DU), the RAN node may include blocks other than those included in FIG. 10. For example, the RF processor 10 and baseband processor 20 may be configured to include a controller, a storage, and a backhaul communicator for communication with the CU in the DU, or the backhaul communicator 30 may be configured to include a controller, a storage, a backhaul communicator for communication with the DU and core network in the CU. The CU may be responsible for the functions of the CU-CP and CU-UP. In addition, in case that the eNB is split into the eNB-CP and the eNB-UP, the eNB may include blocks other than those included in FIG. 10. For example, the RF processor 10 and baseband processor 20 may be configured to include a controller, a storage, and a backhaul communicator for communication with the eNB-UP and core network in the eNB-CP, or the backhaul communicator 30 may be configured to include a controller, a storage, a backhaul communicator for communication with the eNB-UP and core network in the eNB-UP.

The RF processor 10 may perform functions for transmitting and receiving signals through radio channels, e.g., band conversion and amplification of signals. The RF processor 10 may up-convert a baseband signal provided from the baseband processor 20, into a RF band signal and then transmit the RF band signal through an antenna, and down-convert an RF band signal received through an antenna, into a baseband signal.

For example, the RF processor 10 may include a transmitting filter, a receiving filter, an amplifier, a mixer, an oscillator, a DAC, an ADC, and the like. Although only one antenna is illustrated in FIG. 10, this is only an example and the first access node may include a plurality of antennas. In addition, the RF processor 10 may include a plurality of RF chains. Further, the RF processor 10 may perform beamforming. For beamforming, the RF processor 10 may adjust phases and sizes of signals to be transmitted or having received through a plurality of antennas or antenna elements. The RF processor 10 may perform a downlink MIMO by transmitting one or more layers of layers.

The baseband processor 20 may convert between a baseband signal and a bitstream based on PHY layer specifications of a first radio access technology. For example, for data transmission, the baseband processor 20 may generate complex symbols by encoding and modulating a transmit bitstream. In addition, for data reception, the baseband processor 20 may reconstruct a received bitstream by demodulating and decoding a baseband signal provided from the RF processor 10. For example, according to an OFDM scheme, for data transmission, the baseband processor 20 may generate complex symbols by encoding and modulating a transmit bitstream, map the complex symbols to subcarriers, and then constitute OFDM symbols by performing IFFT operation and CP insertion. In addition, for data reception, the baseband processor 20 may segment a baseband signal provided from the RF processor 10, into OFDM symbol units, reconstruct signals mapped to subcarriers by performing FFT operation, and then reconstruct a received bitstream by demodulating and decoding the signals. The baseband processor 20 and RF processor 10 may transmit and receive signals as described above. Therefore, the baseband processor 20 and RF processor 10 may also be called a transmitter, a receiver, a transceiver, a communicator, or a wireless communicator.

The backhaul communicator 30 may provide an interface for communicating with other nodes in the network. The backhaul communicator 30 may convert a bit string transmitted from the main RAN Node or eNB to another node, for example, an auxiliary base station, a core network, etc., into a physical signal, and convert the physical signal received from the other node into a bit string.

The storage 40 may store basic programs, application programs, and data, e.g., configuration information, for operations of the main RAN node and eNB. In particular, the storage 40 may store information about bearers assigned to the connected UE, measurement results reported from the connected UE, etc. In addition, the storage 40 may store information that serves as a criterion for determining whether to provide or suspend multiple connections to the UE. In addition, the storage 40 may provide stored data upon request from the controller 50.

The controller 50 may control overall operations of the RAN node and eNB. For example, the controller 50 may transmit and receive signals through the baseband processor 20 and RF processor 10 or through the backhaul communicator 30. In addition, the controller 50 may record and read data on or from the storage 40. The controller 50 may include at least one processor.

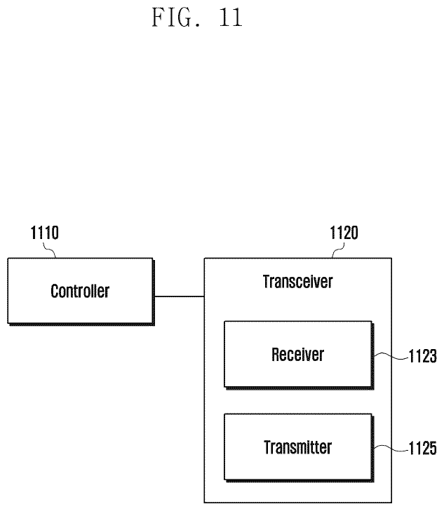

FIG. 11 illustrates a diagram of a structure of a terminal according to an embodiment of the disclosure.

With reference to FIG. 11, a terminal according to an embodiment of the disclosure may include a transceiver 1120 and a controller 1110 controlling the overall operation of the terminal. Further, the transceiver 1120 may include a transmitter 1125 and a receiver 1123.

The transceiver 1120 may transmit and receive signals with other network entities.

The controller 1110 may control the terminal to perform any one of the operations according to the above-described embodiments. On the other hand, it is not always necessary for the controller 1110 and transceiver 1120 to be implemented by separate modules, but they may be implemented as one constituent element in the form of a single chip. Further, the controller 1110 and transceiver 1120 may be electrically connected to each other. For example, the controller 1110 may be a circuit, an application-specific circuit, or at least one processor. Further, the operations of the terminal may be implemented by providing a memory device in which corresponding program codes are stored in a certain constituent element of the terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a control plane (CP) of a base station in a wireless communication system, the method comprising:
transmitting, to a user plane (UP) of the base station, a first message comprising information on a packet data convergence protocol (PDCP) for each data radio bearer (DRB); and
as a response to the first message, receiving, from the UP of the base station, a second message,
wherein the information on the PDCP for each DRB comprises at least one PDCP version information.

2. The method of claim 1,
wherein the first message is a bearer context setup request message or a bearer context modification request message, and
wherein the second message is a bearer context setup response message or a bearer context modification response message.

3. The method of claim 1,
wherein the information on the PDCP for each DRB is associated with a PDCP version for a PDCP configuration.

4. The method of claim 1,
wherein the at least one PDCP version information comprises at least one of an evolved universal terrestrial radio access (E-UTRA) PDCP, or a new radio (NR) PDCP.

5. The method of claim 1, further comprising
receiving, from the UP of the base station, a third message comprising information on the PDCP supported by the UP of the base station.

6. A method performed by a user plane (UP) of a base station in a wireless communication system, the method comprising:
receiving, from a control plane (CP) of the base station, a first message comprising information on a packet data convergence protocol (PDCP) for each data radio bearer (DRB); and
as a response to the first message, transmitting, to the CP of the base station, a second message,
wherein the information on the PDCP for each DRB comprises at least one PDCP version information.

7. The method of claim 6,
wherein the first message is a bearer context setup request message or a bearer context modification request message, and
wherein the second message is a bearer context setup response message or a bearer context modification response message.

8. The method of claim 6,
wherein the information on the PDCP for each DRB is associated with a PDCP version for a PDCP configuration.

9. The method of claim 6,
wherein the at least one PDCP version information comprises at least one of an evolved universal terrestrial radio access (E-UTRA) PDCP, or a new radio (NR) PDCP.

10. The method of claim 6, further comprising
transmitting, to the CP of the base station, a third message comprising information on the PDCP supported by the UP of the base station.

11. A control plane (CP) of a base station in a wireless communication system, the CP of the base station comprising:
a transceiver; and
at least one processor coupled with the transceiver and configured to:
transmit, to a user plane (UP) of the base station, a first message comprising information on a packet data convergence protocol (PDCP) for each data radio bearer (DRB), and
as a response to the first message, receive, from the UP of the base station, a second message,
wherein the information on the PDCP for each DRB comprises at least one PDCP version information.

12. The CP of the base station of claim 11,
wherein the first message is a bearer context setup request message or a bearer context modification request message, and
wherein the second message is a bearer context setup response message or a bearer context modification response message.

13. The CP of the base station of claim 11,
wherein the information on the PDCP for each DRB is associated with a PDCP version for a PDCP configuration.

14. The CP of the base station of claim 11,
wherein the at least one PDCP version information comprises at least one of an evolved universal terrestrial radio access (E-UTRA) PDCP, or a new radio (NR) PDCP.

15. The CP of the base station of claim 11, wherein the at least one processor is further configured to:
receive, from the UP of the base station, a third message comprising information on the PDCP supported by the UP of the base station.

16. A user plane (UP) of a base station in a wireless communication system, the UP of the base station comprising:
a transceiver; and
at least one processor coupled with the transceiver and configured to:
receive, from a control plane (CP) of the base station, a first message comprising information on a packet data convergence protocol (PDCP) for each data radio bearer (DRB), and
as a response to the first message, transmit, to the CP of the base station, a second message,
wherein the information on the PDCP for each DRB comprises at least one PDCP version information.

17. The UP of the base station of claim 16,
wherein the first message is a bearer context setup request message or a bearer context modification request message, and
wherein the second message is a bearer context setup response message or a bearer context modification response message.

18. The UP of the base station of claim 16,
wherein the information on the PDCP for each DRB is associated with a PDCP version for a PDCP configuration.

19. The UP of the base station of claim 16,
wherein the at least one PDCP version information comprises at least one of an evolved universal terrestrial radio access (E-UTRA) PDCP, or a new radio (NR) PDCP.

20. The UP of the base station of claim 16, wherein the at least one processor is further configured to:
transmit, to the CP of the base station, a third message comprising information on the PDCP supported by the UP of the base station.
